(19) United States
(12) Patent Application Publication
(10) Pub. No.: US 2015/0240846 A1
(43) Pub. Date: Aug. 27, 2015

(54) CLAMPING SYSTEM FOR MOUNTING ACCESSORIES TO FRAME ASSEMBLY

(71) Applicant: Caterpillar Inc., Peoria, IL (US)

(72) Inventor: Jacob R. Rogers, Decatur, IL (US)

(73) Assignee: Caterpillar Inc., Peoria, IL (US)

(21) Appl. No.: 14/710,640

(22) Filed: May 13, 2015

(51) Int. Cl. F16B 2/10

(52) U.S. Cl. CPC F16B 2/10

(57) ABSTRACT

A clamping system to mount accessories to a frame assembly is provided. The frame assembly includes a plurality of frame members. The clamping system includes a clamp, a mounting bracket, and a tab member. The clamp includes a first lip portion, a second lip portion, and at least two securing members with an inner periphery. Each of the first lip portion and the second lip portion is attached to the two securing members. The first lip portion and the second lip portion are lockable relative to each other. Each of the two securing members includes at least three grooves on the inner periphery. The mounting bracket is attached to the clamp to mount the one or more accessories. The tab member is disposed on an outer surface of at least one of the plurality of the frame members. The tab member engages with one of the at least three grooves.

### TECHNICAL FIELD

The present disclosure relates to frame assemblies of machines. More particularly, the present disclosure relates to a clamping system to mount accessories to frame assembly.

### BACKGROUND

Machines of all types necessarily require a frame to enable the machine to provide structural support to various components, such as power generating unit, electrical and electronic components, pumps, motors, tubes, hoses, and the like to withstand high forces. These forces may not only be generated from movement of the machine over uneven and rugged terrains, but also from operational forces of various accessories that are attached to the frame. All these accessories may impart various types of loads to the frame from various locations acting at various angles. Therefore, it may be necessary to design the frame to accommodate various types of loads. To provide mounting features to such accessories, various components are attached to the frames, such as bosses, blocks, and other features welded onto the frame of the machines. Each mounting portion of the frame may include dimensions necessary to accommodate various accessories. It may sometimes get very tedious to design the frame for mounting of various accessories with sufficient clearances between the components, in particular to support loosely held components such as hoses, wires, and the like. It may be required to increase the clearance between accessories or to prevent the accessories from rubbing against each other in the frame, during working of the machine.

Conventionally, the hydraulic accessories, such as hoses, may be coupled to the frame via clamps, such as U-bolts. U-bolts may be prone to sliding, which may result in rubbing of the accessories against each other. Moreover, the above mentioned conventional ways to mount accessories to the frame may require a substantial amount of welding that may be both difficult and expensive to do. It will be understood by those skilled in the art that it is highly desirable to simplify a mounting structure for the frame to increase the efficiency in carrying forces and overall use.

U.S. Pat. No. 3,454,305 discloses a dual-axle mount, which is structured to be coupled to an axle via one or more bolts. However, the '305 reference does not discuss a provision to mount accessories to a frame assembly of a machine in an adjustable manner, such that there is no rubbing of the accessories against each other.

### SUMMARY OF THE INVENTION

Various aspects of the present disclosure describe a clamping system to mount one or more accessories to a frame assembly. The frame assembly includes a plurality of frame members. The clamping system includes a clamp, a mounting bracket, and at least one tab member. The clamp includes a first lip portion, a second lip portion, and at least two securing members. Each of the two securing members includes an inner periphery. Each of the first lip portion and the second lip portion is positioned at a first end of the two securing members such that the first lip portion and the second lip portion extend from the first end of the two securing members. The first lip portion and the second lip portion are lockable relative to each other. The first lip portion and the second lip portion facilitate maintenance of the clamp in a locked state with the frame assembly. The two securing members include at least three grooves arranged on the inner periphery. The mounting bracket is coupled to at least one of the first lip portion and the second lip portion of the clamp. The mounting bracket is configured to mount the one or more accessories. The tab member is disposed on an outer surface of at least one of the plurality of frame members. The tab member is configured to engage with one of the at least three grooves, in the locked state. This limits a rotational displacement of the clamp relative to the at least one of the plurality of the frame members.

### BRIEF DESCRIPTION OF THE DRAWINGS

FIG. 1 is a perspective view of an exemplary frame assembly with a plurality of frame members, in accordance with the concepts of the present disclosure;

FIG. 2 is a perspective detailed view of a portion of the frame assembly of FIG. 1, illustrating the frame members coupled to a clamping system, in accordance with the concepts of the present disclosure;

FIG. 3 is a perspective view of an embodiment of a clamp of the clamping system of FIG. 2 in an open state, in accordance with the concepts of the present disclosure; and

FIG. 4 is a perspective view of another embodiment of the clamp of the clamping system of FIG. 2 in a closed state, in accordance with the concepts of the present disclosure.

### DETAILED DESCRIPTION

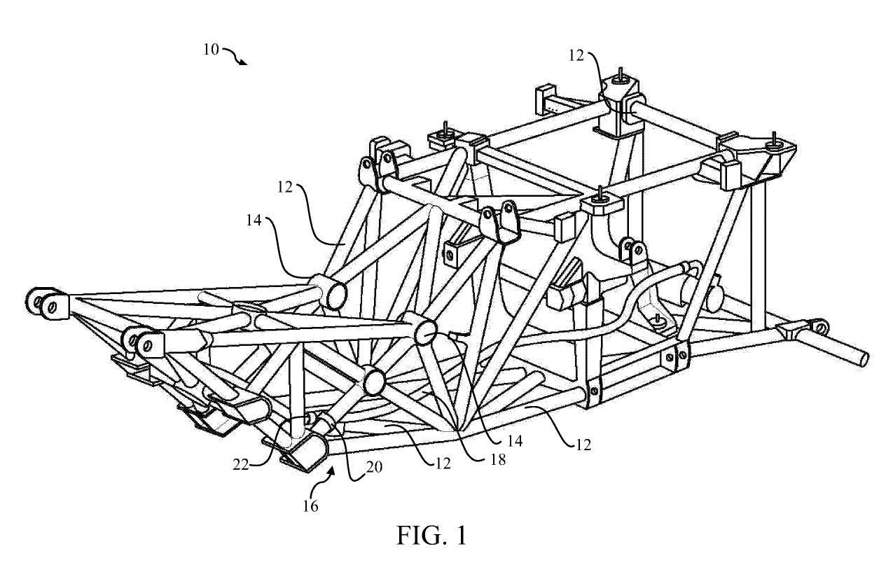

Referring to FIG. 1, there is shown a frame assembly 10 for a machine (not shown). The frame assembly 10 is structured and configured to facilitate mounting of certain system accessories, such as fluid hoses, electrical wires, and/or the like (not shown). The exemplary frame assembly 10 includes a plurality of frame members 12, which may be fabricated or casted. The frame members 12 are tubular in shape and are partially in plane with or perpendicular to each other. Three or more frame members 12 are connected to a hub 14. There may be a number of hubs 14 in the frame assembly 10 that connect the frame members 12, such that the frame members 12 need not be always in plane with or perpendicular to each other.

The frame assembly 10 is equipped with a clamping system 16 to facilitate attachment of accessories, such as a hose 18 to the frame member 12. As illustrated in FIG. 1, the clamping system 16 holds the hose 18 connected to a hydraulic system, for example an axle system (not shown). The clamping system 16 may be used to mount various other accessories to the frame assembly 10.

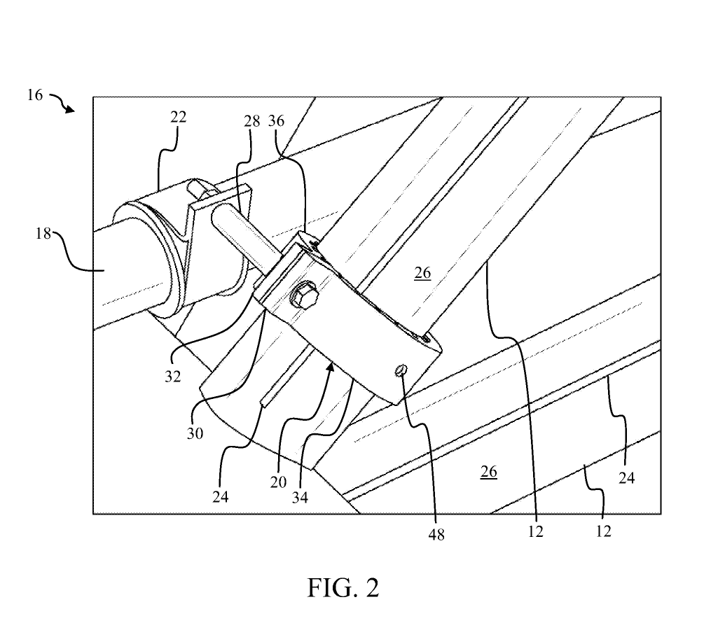

Referring to FIG. 2, there is shown a portion of the frame assembly 10 with the clamping system 16. The clamping system 16 includes a clamp 20, a mounting bracket 22, and a tab member 24. The tab member 24 is a longitudinal bead positioned on an outer surface 26 of the frame member 12, such that the tab member 24 protrudes externally from the outer surface 26. The tab member 24 is parallel to a longitudinal axis of the frame member 12. The tab member 24 may run partially or fully along a length of the frame member 12. In an embodiment, the frame member 12 may include more than one tab member 24. In such a case, the tab member 24 is structured to align and fit with the clamp 20. This allows the clamp 20 to be indexed in a manner so as to control an angle of orientation with respect to the frame member 12. It also prevents the clamp 20 from unexpected rotation during the life of the clamp 20. The clamp 20 is attached to the mounting bracket 22 via a first fastener 28. The first fastener 28 is fastened to the mounting bracket 22, via a mounting hole (not shown) of the mounting bracket 22. The mounting bracket 22 is used to mount the one or more accessories.

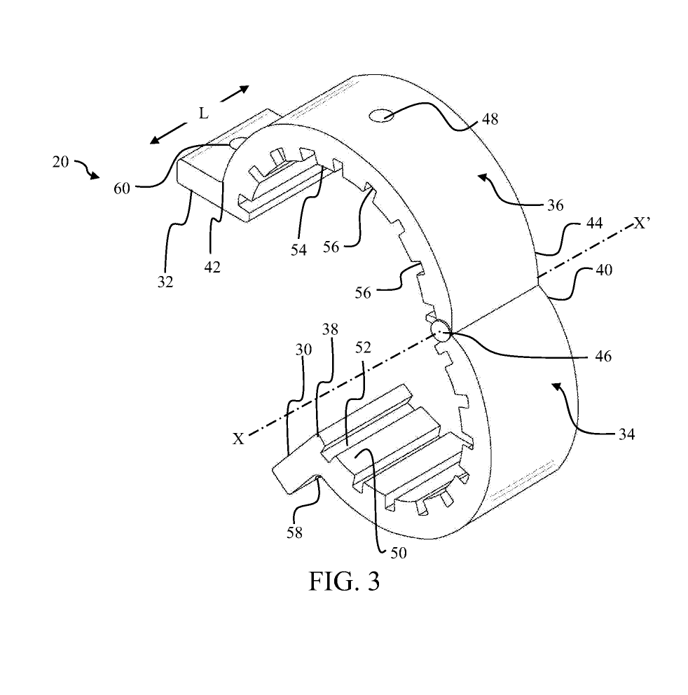

Referring to FIG. 3, the clamp 20 includes a first lip portion 30, a second lip portion 32, a first securing member 34, and a second securing member 36. The clamp 20 has a clamp length (L). The first securing member 34 includes a first end 38 and a second end 40. Similarly, the second securing member 36 includes a first end 42 and a second end 44. The first securing member 34 is pivotably attached to the second securing member 36. The second end 40 of the first securing member 34, is pivotally attached to the second end 44 of the second securing member 36, via a second fastener 46. This allows pivotal movement of each of the first securing member 34 and the second securing member 36 about a pivot axis X-X′. When the pivotal movement of the first securing member 34 is towards the second securing member 36, the lip portions 30 and 32 come in contact with each other, to facilitate maintenance of the clamp 20 in a locked state with the frame assembly 10 (FIG. 1). The locked state may also be attained by the clamp 20 by the pivotal movement of the second securing member 36 towards the first securing member 34. When the pivotal movement of the first securing member 34 and the second securing member 36 is away from each other, an open state of the clamp 20 is attained. The first securing member 34 includes a hole 48, which may be a threaded hole. The hole 48 may be used for attachment of a P-clip, or similar fastener to hold the hose 18 in place. Similarly, the second securing member 36 may also include one or more holes (not shown).

Each of the first securing member 34 and the second securing member 36 is of a length equal to the clamp length (L). The first securing member 34 includes an inner periphery 50. The inner periphery 50 is structured to include multiple grooves 52, which are provided to a pre-determined depth in the inner periphery 50. The grooves 52 are equally spaced with respect to each other and are arranged solely along the inner periphery 50. In an embodiment, the grooves 52 may be unequally spaced with respect to each other and are arranged solely along the inner periphery 50. The grooves 52 run along the clamp length (L). The grooves 52 are U-shaped such that the grooves 52 may fit with the tab member 24 of the frame member 12 (FIG. 2). The tab member 24 is structured to engage with the groove 52 to limit a rotational displacement of the clamp 20 relative to the frame member 12 (FIG. 2), in the locked state. This allows the clamp 20 to be indexed in a manner so as to control its angle of orientation with respect to the frame member 12 (FIG. 2).

Similarly, the second securing member 36 includes an inner periphery 54. The inner periphery 54 is structured to include multiple grooves 56, which are machined to a depth in the inner periphery 54. The grooves 56 are equally spaced with respect to each other and are arranged solely along the inner periphery 54. The grooves 56 run along the clamp length (L). The grooves 56 are U-shaped so as to accommodate the tab member 24 of the frame member 12 (FIG. 2). The tab member 24 is structured to engage and fit with the groove 56, to limit the rotational displacement of the clamp 20 relative to the frame member 12 (FIG. 2), in the locked state. The tab member 24 engages with one of the groove 52 or the groove 56 of the clamp 20, which allows the clamp 20 to slide along the length of the frame member 12 (FIG. 2).

The first lip portion 30 and the second lip portion 32 are lockable relative to each other. In the locked state of the clamp 20, the first securing member 34 and the second securing member 36 are arranged such that the first lip portion 30 and the second lip portion 32 are in contact with each other. The first lip portion 30 is integrally attached to the first end 38 of the first securing member 34. The first lip portion 30 is a planar portion, which extends outwards from an attachment of the first lip portion 30 and the first securing member 34 (that is, the first end 38). In an exemplary embodiment, the first lip portion 30 is aligned at an obtuse angle to the first securing member 34. The first lip portion 30 includes a first securing hole 58. Similarly, the first end 42 of the second securing member 36 is integrally attached to the second lip portion 32. The second lip portion 32 is a planar portion, which extends outwards from an attachment of the second lip portion 32 and the second securing member 36 (that is, the first end 42). In an exemplary embodiment, the second lip portion 32 is aligned at an obtuse angle to the second securing member 36. The second lip portion 32 includes a second securing hole 60, which is positioned in such a way that the second securing hole 60 aligns with the first securing hole 58, in the locked state of the clamp 20. The first securing hole 58 and the second securing hole 60 are structured to facilitate fastening of the first securing member 34 and the second securing member 36 via the first fastener 28 (FIG. 2). The first securing hole 58 and the second securing hole 60 may be threaded internally. In an embodiment, the first lip portion 30 and the second lip portion 32 may be inclined to the first securing member 34 and the second securing member 36, respectively, at other angles, so as to facilitate engagement of the lip portions 30 and 32 to close the clamp 20. The locking mechanism of the clamp 20 along with the mounting bracket 22 will be explained hereafter.

Referring to FIG. 2, the clamp 20 is in the locked state and is attached to the mounting bracket 22. The mounting bracket 22 is attached to the lip portions 30 and 32, via the first fastener 28. In the locked state of the clamp 20, the first fastener 28 passes through the securing holes 58 and 60 of the lip portions 30 and 32, and passes through the mounting hole (not shown) of the mounting bracket 22. This facilitates coupling of the mounting bracket 22 to the clamp 20. The mounting bracket 22 is structured to hold the hose 18. Thus the clamp 20 may act as the base point to mount hydraulic accessories and electrical accessories. In an embodiment, the mounting brackets 22 may be of different shapes and sizes so as to hold different accessories.

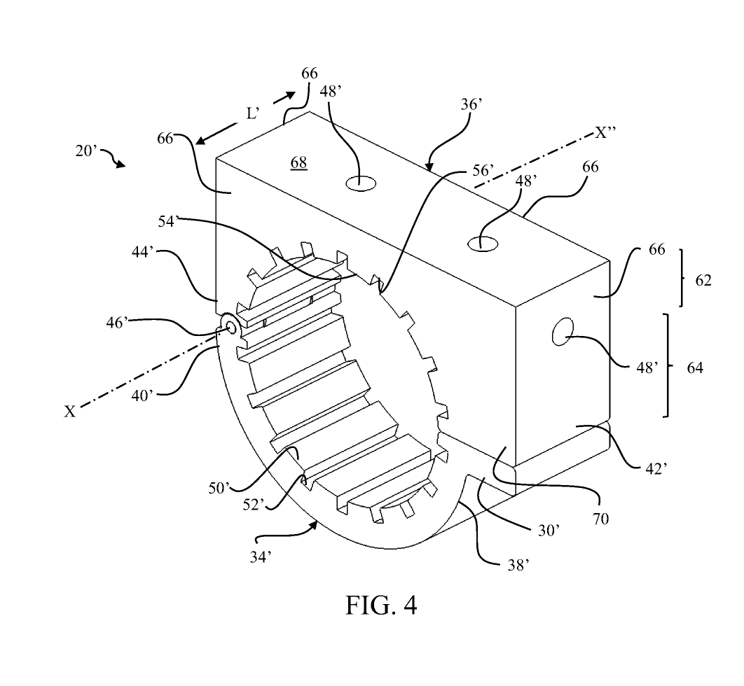

Referring to FIG. 4, there is shown a clamp 20′, which is an embodiment of the clamp 20. The clamp 20′ is shown in the closed state. The clamp 20′ has a clamp length (L′). The clamp 20′ includes a first lip portion 30′, a first securing member 34′, and a second securing member 36′. Each of the first securing member 34′ and the second securing member 36′ is of a length equal to the clamp length (L′). The first securing member 34′ includes a first end 38′ and a second end 40′. In addition, the first securing member 34′ includes an inner periphery 50′. The inner periphery 50′ is structured to include multiple grooves 52′, which are provided to a pre-determined depth in the inner periphery 50′. The grooves 52′ are equally spaced with respect to each other and are arranged solely along the inner periphery 50′. In an embodiment, the grooves 52′ may be unequally spaced with respect to each other and are arranged solely along the inner periphery 50′. The grooves 52′ run along the clamp length (L′). The grooves 52′ are U-shaped such that the grooves 52′ may fit with the tab member 24 of the frame member 12 (FIG. 2). The tab member 24 is structured to engage with the groove 52′ to limit a rotational displacement of the clamp 20′ relative to the frame member 12 (FIG. 2), in the locked state. This allows the clamp 20′ to be indexed in a manner so as to control its angle of orientation with respect to the frame member 12 (FIG. 2).

Similarly, the second securing member 36′ includes a first end 42′ and a second end 44′. The second securing member 36′ also includes a first portion 62 and a second portion 64. The first portion 62 includes four walls 66 and an external surface 68 defined by the four walls 66. The second portion 64 includes a semi-circular portion with an inner periphery 54′. The inner periphery 54′ extends away from the inner periphery 54′ towards the first end 42′, to define an engaging portion 70. The engaging portion 70 includes a length, which is equal to the first lip portion 30′. The inner periphery 54′ is structured to include multiple grooves 56′, which are machined to a depth in the inner periphery 54′. The grooves 56′ are equally spaced with respect to each other and are arranged solely along the inner periphery 54′. The grooves 56′ run along the clamp length (L′). The grooves 56′ are U-shaped so as to accommodate the tab member 24 of the frame member 12 (FIG. 2). The tab member 24 is structured to engage and fit with the groove 56′, to limit the rotational displacement of the clamp 20′ relative to the frame member 12 (FIG. 2), in the locked state. The tab member 24 engages with one of the groove 52′ or the groove 56′ of the clamp 20′, which allows the clamp 20′ to slide along the length of the frame member 12 (FIG. 2).

The first lip portion 30′ and the engaging portion 70 are lockable relative to each other. In the locked state of the clamp 20′, the first securing member 34′ and the second securing member 36′ are arranged such that the first lip portion 30′ and the engaging portion 70 are in contact with each other. The first lip portion 30′ is integrally attached to the first end 38′ of the first securing member 34′. The first lip portion 30′ is a planar portion, which extends outwards from an attachment of the first lip portion 30′ and the first securing member 34′ (that is, the first end 38′). In an exemplary embodiment, the first lip portion 30′ is aligned at an obtuse angle to the first securing member 34′. The first lip portion 30′ may include a first securing hole (not shown). The engaging portion 70 may include a second securing hole (not shown), which is positioned in such a way that the second securing hole (not shown) aligns with the first securing hole (not shown), in the locked state of the clamp 20′. The first securing hole (not shown) and the second securing hole (not shown) are structured to facilitate fastening of the first securing member 34′ and the second securing member 36′ via a fastener (not shown). The first securing hole (not shown) and the second securing hole (not shown) may be threaded internally. The locking mechanism of the clamp 20′ along with the mounting bracket 22 is similar to locking mechanism of the clamp 20 as explained in description for FIG. 2.

The first securing member 34′ is pivotably attached to the second securing member 36′. The second end 40′ of the first securing member 34′, is pivotally attached to the second end 44′ of the second securing member 36′, via a second fastener 46′. This allows pivotal movement of each of the first securing member 34′ and the second securing member 36′ about a pivot axis X-X″. When the pivotal movement of the first securing member 34′ is towards the second securing member 36′, the lip portion 30′ and the engaging portion 70 come in contact with each other, to facilitate maintenance of the clamp 20′ in the locked state with the frame assembly 10 (FIG. 1). The locked state is attained by the clamp 20′ by the pivotal movement of the second securing member 36′ towards the first securing member 34′. When the pivotal movement of the first securing member 34′ and the second securing member 36′ is away from each other, an open state of the clamp 20′ may be attained. The walls 66 includes two holes 48′ and the external surface 68 includes one hole 48′, which may be threaded holes. The holes 48′ may be used for attachment of a P-clip, or similar fastener to hold the hose 18 in place. Similarly, the first securing member 34′ may also include one or more holes (not shown).

### INDUSTRIAL APPLICABILITY

In operation, the frame assembly 10 is provided with the clamping system 16. This allows the accessories to be mounted to the frame members 12 of the frame assembly 10. Multiple clamps 20, 20′ of the clamping system 16 are fastened around the frame members 12, to allow attachment of the mounting brackets 22. Such mounting brackets 22 hold accessories, such as hydraulic pipes, electrical wires, and/or the like. The clamps 20, 20′ are engaged to the frame members 12 via the tab members 24. Thus the disclosed clamping system 16 allows the clamp 20, 20′ to be indexed in a controlled manner to control an angle of orientation of the clamp 20, 20′ with respect to the frame members 12. Further, tight gripping engagement of the tab member 24 with one of the groove 52, 52′ or the groove 56, 56′ of the clamp 20, 20′ also prevents rotation of the clamp 20, 20′, which thereby provides stability to the mounting of the accessories. Since all the frame members 12 include the tab members 24, the clamps 20, 20′ can be clipped anywhere onto all the frame members 12 and are capable of sliding along the length of the frame members 12. This makes the disclosed frame assembly 10 and the clamping system 16 suitable to mount the accessories and gives controllable adjustability to a clipping strategy. In addition, the disclosed frame assembly 10 and clamping system 16 are cost effective and efficient to manufacture. With elimination of requirement for welds, the frame assembly 10 is stable and there is optimum distribution of stress and loads.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to those skilled in the art. It is not desired to limit the disclosure to the exact construction and operation illustrated and described, and, accordingly, all suitable modifications and equivalents may be resorted to that fall within the scope of the disclosure.

What is claimed is:

1. A clamping system for mounting one or more accessories to a frame assembly, the frame assembly including a plurality of frame members, the clamping system comprising:
a clamp having a first lip portion, a second lip portion and at least two securing members with an inner periphery, each of the first lip portion and the second lip portion being positioned at a first end of the at least two securing members such that the first lip portion and the second lip portion extend therefrom, wherein the first lip portion and the second lip portion are lockable relative to each other, and facilitate maintenance of the clamp in a locked state with the frame assembly, the at least two securing members including at least three grooves arranged on the inner periphery;
a mounting bracket coupled to at least one of the first lip portion and the second lip portion of the clamp, the mounting bracket configured to mount the one or more accessories; and
at least one tab member disposed on an outer surface of at least each of the plurality of the frame members and configured to engage with one of the at least three grooves, in the locked state, thereby limiting a rotational displacement of the clamp relative to the at least one of the plurality of the frame members.
